(19) United States
(12) Patent Application Publication
(10) Pub. No.: US 2013/0057799 A1
(43) Pub. Date: Mar. 7, 2013

(54) SHORTING BAR ASSEMBLY, LCD PANEL AND LCD

(71) Applicant: Yizhuang Zhuang, Shenzhen (CN)

(72) Inventor: Yizhuang Zhuang, Shenzhen (CN)

(73) Assignee: Shenzhen China Star Optoelectronics Technology Co. Ltd., Shenzhen, Guangdong (CN)

(21) Appl. No.: 13/376,195

(22) PCT Filed: Sep. 20, 2011
(86) PCT No.: PCT/CN11/79853

§ 371 Date: Dec. 5, 2011

(30) Foreign Application Priority Data
Sep. 7, 2011 (CN) 201120334894.X

(51) Int. Cl. G02F 1/1333

(52) U.S. Cl. 349/54

(57) ABSTRACT

A shorting bar assembly is disclosed. The shorting bar assembly comprises signal lines and shorting bars. Each of the signal lines has one end connected to a wiring in a liquid crystal display (LCD) panel via a pad and the other end connected to one of the shorting bars. Each of the signal lines has a width smaller than that of the wiring and has a bent section. A liquid crystal display (LCD) panel comprising the shorting bar assembly and an LCD comprising the LCD panel are also disclosed. According to the shorting bar assembly, the LCD panel and the LCD of the present disclosure, both the width and the area of the signal lines for connecting the short bars with the wirings in the LCD panel are reduced, so the production efficiency of LCD panels can be improved and the production cost can be lowered.

### BACKGROUND

1. Technical Field

The present disclosure relates to the field of liquid crystal displaying (LCD), and more particularly, to a shorting bar assembly, an LCD panel and an LCD.

2. Description of Related Art

An LCD mainly comprises an LCD panel and a backlight module, and the LCD panel comprises a display region and a wiring region adjoining the display region. The display region comprises a plurality of data lines and scan lines, and the wiring region comprises wirings connected with the data lines and the scan lines. Usually in a cell process for manufacturing a flat panel LCD device, the wirings are connected to shorting bars via signal lines, and a signal is inputted by an image detector to a testing point of the shorting bars for testing of images on the LCD panel. For the LCD panels that pass the image testing, a laser must be used to sever portions of the signal lines that connect with the wirings so that the LCD panels can be used in subsequent processes.

Connections between the signal lines and the wirings in the prior art are as shown in FIG. 1. Below a pad 3 is a signal line section 1, and a wiring 2 is connected to a shorting bar via the signal line section 1. The signal line 1 has a width identical to that of the wiring 2 and extends vertically. In this structure, the signal line 1 occupies an area substantially equal to that of the wiring 2. However, as the size of display panels becomes increasingly larger nowadays, the area of connecting portions between signal lines and wirings that have to be severed by laser in LCD panels passing the image test becomes larger. Correspondingly, duration of the severing process is extended. Therefore, this wiring structure adopted for the short bars leads to a low production efficiency and high production cost.

### BRIEF SUMMARY OF THE DISCLOSURE

A primary objective of the present disclosure is to provide a shorting bar assembly, an LCD panel and an LCD, which can reduce the width and the area of signal lines for connecting shorting bars with wirings in the LCD panel so as to improve the production efficiency and lower the production cost of LCD panels.

The present disclosure provides a shorting bar assembly comprising signal lines and shorting bars. Each of the signal lines having one end connected to a wiring in an LCD panel via a pad and the other end connected to one of the shorting bars. Each of the signal lines has a width smaller than that of the wiring and has a bent section.

Preferably, the bent section of each of the signal lines is bent from an end of the shorting bar towards a center of the shorting bar. Preferably, a portion of each of the signal lines that connects with the wiring is vertical.

Preferably, the signal lines are arranged in two groups with the center of each of the shorting bars as a boundary.

Preferably, the wirings are connected to data lines or scan lines in a display region of the LCD panel.

Preferably, the wirings are connected to the shorting bars via the signal lines in an alternating wiring arrangement or an RGB wiring arrangement.

The present disclosure also provides an LCD panel comprising a shorting bar assembly. The shorting bar assembly comprises signal lines and shorting bars. Each of the signal lines has one end connected to a wiring in the LCD panel via a pad and the other end connected to one of the shorting bars. Each of the signal lines has a width smaller than that of the wiring and has a bent section.

Preferably, the bent section of each of the signal lines is bent from an end of the shorting bar towards a center of the shorting bar.

Preferably, a portion of each of the signal lines that connects with the wiring is vertical.

Preferably, the signal lines are arranged in two groups with the center of each of the shorting bars as a boundary.

Preferably, the wirings are connected to data lines or scan lines in a display region of the LCD panel.

Preferably, the wirings are connected to the shorting bars via the signal lines in an alternating wiring arrangement or an RGB wiring arrangement.

The present disclosure further provides an LCD comprising an LCD panel. The LCD panel comprises a shorting bar assembly. The shorting bar assembly comprises signal lines and shorting bars. Each of the signal lines has one end connected to a wiring in the LCD panel via a pad and the other end connected to one of the shorting bars. Each of the signal lines has a width smaller than that of the wiring and has a bent section.

Preferably, the bent section of each of the signal lines is bent from an end of the shorting bar towards a center of the shorting bar.

Preferably, a portion of each of the signal lines that connects with the wiring is vertical.

Preferably, the signal lines are arranged in two groups with the center of each of the shorting bars as a boundary.

Preferably, the wirings are connected to data lines or scan lines in a display region of the LCD panel.

Preferably, the wirings are connected to the shorting bars via the signal lines in an alternating wiring arrangement or an RGB wiring arrangement.

According to the shorting bar assembly, the LCD panel and the LCD of the present disclosure, the signal lines of the shorting bar assembly are designed to have a width smaller than that of the wirings to which they are connected, and meanwhile, each of the signal lines is formed to have a bent section that is bent from an end of a shorting bar towards a center of the shorting bar. This can reduce the connecting area between the signal line and the shorting bar. When a laser is used to sever the portion of the signal line that connects with the wiring after the LCD panel has passed the image testing, the small overall width and the small overall area of the signal line can reduce both the energy and the time necessary for the severing operation. In this way, the production efficiency of LCD panels can be greatly improved and the production cost can be lowered.

### BRIEF DESCRIPTION OF THE DRAWINGS

FIG. 1 is a schematic structural view of a shorting bar assembly in the prior art;

FIG. 2 is a schematic structural view of a first embodiment of a shorting bar assembly according to the present disclosure;

FIG. 3 is a schematic structural view of RGB wirings in the first embodiment of the shorting bar assembly according to the present disclosure;

FIG. 4 is a schematic view illustrating the alternating wiring arrangement of FIG. 2 when the signal lines are severed; and

FIG. 5 is a schematic view illustrating the RGB wiring arrangement of FIG. 3 when the signal lines are severed.

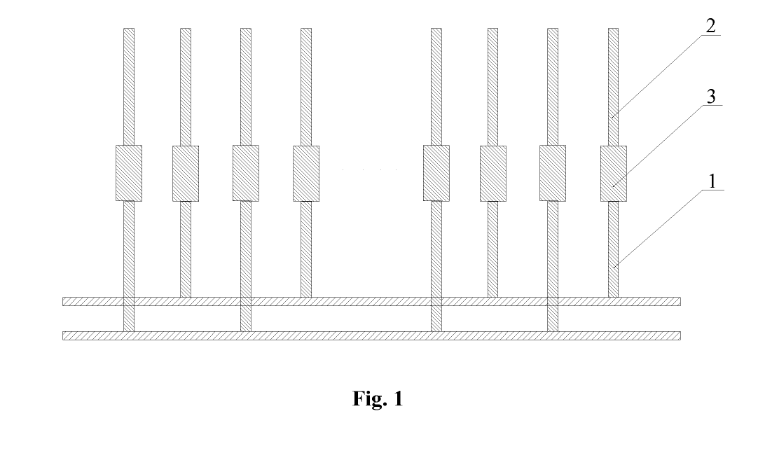

Hereinafter, implementations, functional features and advantages of the present disclosure will be further described with reference to embodiments thereof and the attached drawings.

### DETAILED DESCRIPTION

It shall be understood that, the embodiments described herein are only intended to illustrate but not to limit the present disclosure.

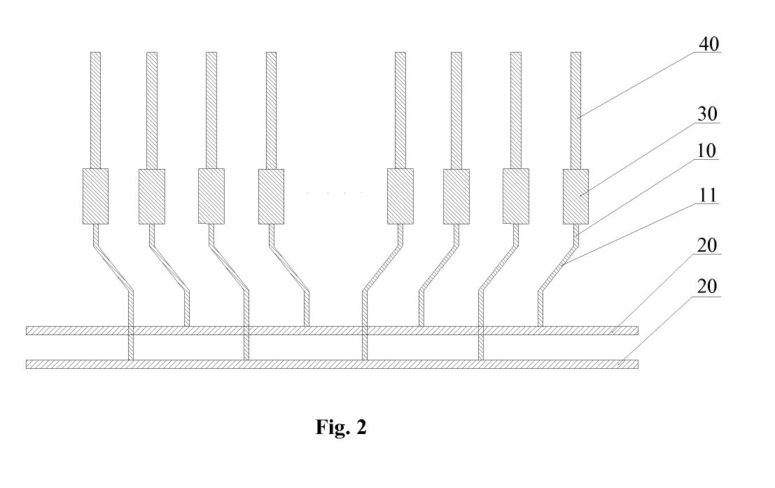

Referring to FIG. 2, there is shown a schematic structural view of a first embodiment of a shorting bar assembly according to the present disclosure.

In this embodiment, the shorting bar assembly comprises signal lines 10 and shorting bars 20. Each of the signal lines 10 has one end connected to a wiring 40 in an LCD panel by being soldered to a pad 30, and has the other end connected to one of the shorting bars 20. In this embodiment, each of the signal lines 10 is designed to have a width smaller than that of the corresponding wiring 40. By connecting the wirings 40 to the shorting bars 20 via the signal lines 10, an image testing can be carried out on the LCD panel. If the LCD panel passes the image testing, then the portions of the signal lines 10 connecting with the wirings 40 will be severed by laser so that the LCD panel can be transferred to the next process to be assembled with a drive circuit module.

According to the shorting bar assembly of this embodiment, by connecting the wirings 40 in the LCD panel to the shorting bars 20 via the signal lines 10, the image testing can be carried out on the LCD panel. The signal lines 10 are designed to have a width smaller than that of the wirings 40, so when a laser is used to sever the portions of the signal lines 10 that connect with the wirings 40 after the LCD panel has passed the image testing, both the energy and the time necessary for the severing operation are reduced. In this way, the production efficiency of LCD panels can be greatly improved and the production cost can be lowered.

In the above embodiment, each of the signal lines 10 has a bent section 11, and the portion of each signal line 10 that connects with the wiring 40 may be vertical. Specifically, a portion of the signal line 10 below the vertical portion may be designed as a bent section 11 which is bent from an end of the shorting bar 20 towards a center of the shorting bar 20. A portion of the signal line 10 that is below the bent section 11 and connects with the shorting bar 20 may be vertical. By designing the signal line 10 to have the bent section 11, the area of the portion of the signal line 10 that connects with the shorting bar 20 can be reduced. Thus, when a laser is used to sever the portion of the signal line 10 that connects with the wiring 40, both the energy of the laser and the time necessary for the severing operation can be reduced.

In this embodiment, the wirings 40 in the LCD panel are connected with the shorting bars 20 via the signal lines 10. This connecting structure may be designed in such a way that the signal lines 10 are divided into two groups with the centers of the shorting bars 20 as a boundary and symmetric with each other. Because each signal line 10 has a bent section 11, this can reduce the area of the portion of each signal line 10 that connects with the shorting bars 10. By dividing the signal lines 10 into two groups and designing each signal line 10 to have a bent section 11, both the energy and the time necessary for the severing operation when a laser is used to sever the signal lines 10 from the wirings 40 can be further reduced.

In the above embodiment, the wirings 40 may be connected to either data lines or scan lines in the display region of the LCD panel, and then the data lines or scan lines are connected to the shorting bars 20 via the signal lines 10. The connecting structure for connecting the data lines or scan lines with the wirings 40 is similar to that described with respect to the shorting bars 20.

In the above embodiment, referring to FIG. 2, connections of the wirings 40 in the display region of the LCD panel to the shorting bars 20 via the signal lines 10 may be in an alternating wiring arrangement; i.e., two shorting bars 20 are used, and among all the wirings 40, those having an odd sequence number are connected to one of the shorting bars 20 via respective signal lines 10 while those having an even sequence number are connected to the other shorting bar 20 via respective signal lines 10.

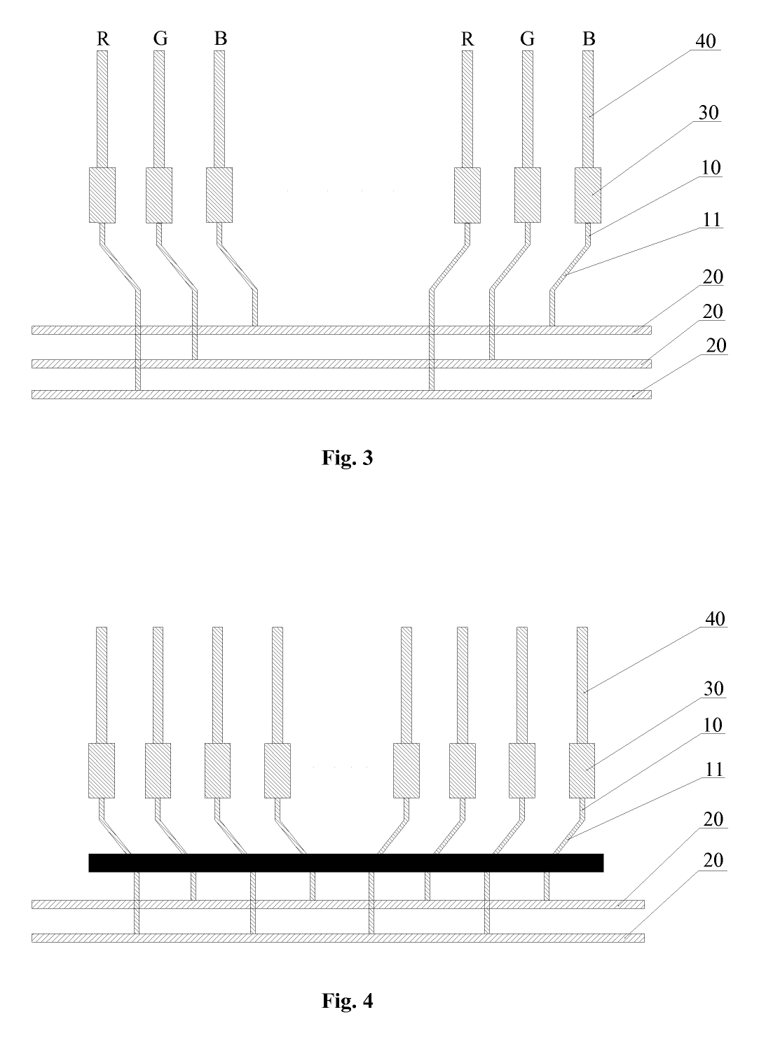

Referring to FIG. 3, there is shown a schematic structural view of RGB wirings in the first embodiment of the shorting bar assembly according to the present disclosure.

In this embodiment, connections of the wirings 40 in the display region of the LCD panel to the shorting bars 20 via the signal lines 10 may also be in an RGB wiring arrangement. In this wiring arrangement, three shorting bars 20 may be adopted, with red signal (R) data lines, green signal (G) data lines and blue signal (B) data lines being connected to the three shorting bars 20 via the signal lines 10 respectively.

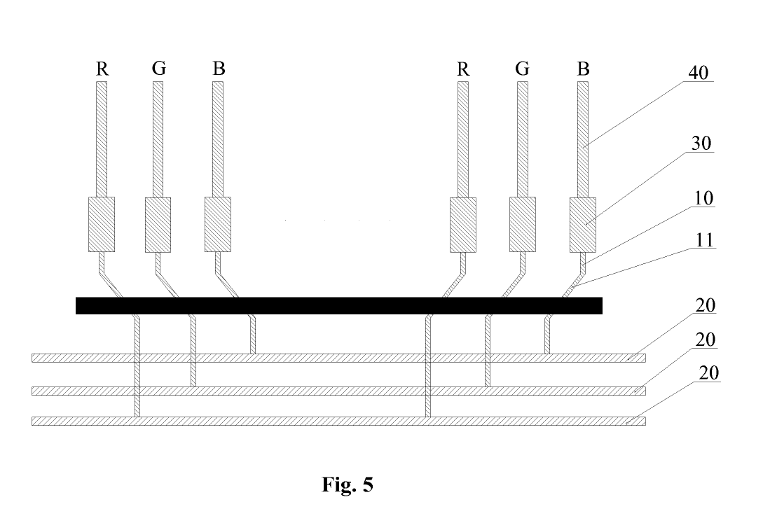

Referring to FIG. 4 and FIG. 5, there are shown schematic views of the first embodiment of the shorting bar assembly when the signal lines 10 are severed.

In this embodiment, the portions of the signal lines 10 that connect with the wirings 40 must be severed by a laser if the LCD panel passes the image testing. FIG. 5 and FIG. 6 are just schematic views illustrating the process of severing the signal lines 10.

The portions of the signal lines 10 that connect with the wirings 40 are severed by a laser so that the LCD panel can be transferred to the next process to be assembled with a drive circuit module. In this embodiment of the present disclosure, because the portion of each signal line 10 that connects with the wiring 40 has a small width and the connecting area between the signal line 10 and the wiring 40 is small, both the energy and the time necessary for the laser severing operation are reduced.

The present disclosure further provides an LCD panel comprising a shorting bar assembly. The shorting bar assembly comprises signal lines 10 and shorting bars 20. Each of the signal lines 10 has one end connected to a wiring 40 in an LCD panel and has the other end connected to one of the shorting bars 20. The signal line 10 may be connected to the wiring 40 through soldering. In this embodiment, each of the signal lines 10 is designed to have a width smaller than that of the corresponding wiring 40. By connecting the wiring 40 to the shorting bar 20 via the signal line 10, an image testing can be carried out on the LCD panel.

Meanwhile, each of the signal lines 10 has a bent section 11, and the portion of each signal line 10 that connects with the wiring 40 may be vertical. Specifically, a portion of the signal line 10 below the vertical portion may be designed as a bent section 11 which is bent from an end of the shorting bar 20 towards a center of the shorting bar 20. A portion of the signal line 10 that is below the bent section 11 and connects with the shorting bar 20 may be vertical. By designing the signal line 10 to have the bent section 11, the area of the portion of the signal line 10 that connects with the shorting bar 20 can be reduced.

If the LCD panel passes the image testing, then the portions of the signal lines 10 that connect with the wirings 40 will be severed so that the LCD panel can be transferred to the next process to be assembled with a drive circuit module. Because the signal lines 10 have a small overall width and the connecting area between the signal lines 10 and the shorting bars 20 is small, both the energy and the time necessary for severing the signal lines 10 are reduced. In this way, the production efficiency of LCD panels can be greatly improved and the production cost can be lowered.

The present disclosure further provides an LCD comprising an LCD panel. The LCD panel comprises a shorting bar assembly.

Embodiments of this LCD encompass all the technical solutions of various embodiments of the shorting bar assembly and the LCD panel described above, and also have the same technical benefits, so the LCD will not be further described herein.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A shorting bar assembly, comprising signal lines and shorting bars, each of the signal lines having one end connected to a wiring in a liquid crystal display (LCD) panel via a pad and the other end connected to one of the shorting bars, wherein each of the signal lines has a width smaller than that of the wiring and has a bent section.

2. The shorting bar assembly of claim 1, wherein the bent section of each of the signal lines is bent from an end of the shorting bar towards a center of the shorting bar.

3. The shorting bar assembly of claim 2, wherein a portion of each of the signal lines that connects with the wiring is vertical.

4. The shorting bar assembly of claim 3, wherein the signal lines are arranged in two groups with the center of each of the shorting bars as a boundary.

5. The shorting bar assembly of claim 4, wherein the wirings are connected to data lines or scan lines in a display region of the LCD panel.

6. The shorting bar assembly of claim 5, wherein the wirings are connected to the shorting bars via the signal lines in an alternating wiring arrangement or an RGB wiring arrangement.

7. An LCD panel comprising a shorting bar assembly, the shorting bar assembly comprising signal lines and shorting bars, each of the signal lines having one end connected to a wiring in the LCD panel via a pad and the other end connected to one of the shorting bars, wherein each of the signal lines has a width smaller than that of the wiring and has a bent section.

8. The LCD panel of claim 7, wherein the bent section of each of the signal lines is bent from an end of the shorting bar towards a center of the shorting bar.

9. The LCD panel of claim 8, wherein a portion of each of the signal lines that connects with the wiring is vertical.

10. The LCD panel of claim 9, wherein the signal lines are arranged in two groups with the center of each of the shorting bars as a boundary.

11. The LCD panel of claim 10, wherein the wirings are connected to data lines or scan lines in a display region of the LCD panel.

12. The LCD panel of claim 11, wherein the wirings are connected to the shorting bars via the signal lines in an alternating wiring arrangement or an RGB wiring arrangement.

13. An LCD comprising an LCD panel, the LCD panel comprising a shorting bar assembly, the shorting bar assembly comprising signal lines and shorting bars, each of the signal lines having one end connected to a wiring in the LCD panel via a pad and the other end connected to one of the shorting bars, wherein each of the signal lines has a width smaller than that of the wiring and has a bent section.

14. The LCD of claim 13, wherein the bent section of each of the signal lines is bent from an end of the shorting bar towards a center of the shorting bar.

15. The LCD of claim 14, wherein a portion of each of the signal lines that connects with the wiring is vertical.

16. The LCD of claim 15, wherein the signal lines are arranged in two groups with the center of each of the shorting bars as a boundary.

17. The LCD of claim 16, wherein the wirings are connected to data lines or scan lines in a display region of the LCD panel.

18. The LCD of claim 17, wherein the wirings are connected to the shorting bars via the signal lines in an alternating wiring arrangement or an RGB wiring arrangement.
